(19) United States
(12) Patent Application Publication
(10) Pub. No.: US 2016/0295097 A1
(43) Pub. Date: Oct. 6, 2016

(54) DUAL CAMERA AUTOFOCUS

(71) Applicant: QUALCOMM Incorporated, San Diego, CA (US)

(72) Inventors: Karthikeyan Shanmugavadivelu, San Diego, CA (US); Hung-Hsin Wu, San Diego, CA (US); Shizhong Liu, San Diego, CA (US); Narayana Karthik Sadanandam Ravirala, San Diego, CA (US); Venkata Ravi Kiran Dayana, San Diego, CA (US); Adarsh Abhay Golikeri, San Diego, CA (US)

(21) Appl. No.: 14/675,283

(22) Filed: Mar. 31, 2015

(51) Int. Cl. H04N 5/232; H04N 5/225

(52) U.S. Cl. CPC H04N 5/23212; H04N 5/2254; H04N 5/2258

(57) ABSTRACT

Exemplary embodiments are directed to dual camera autofocusing in digital cameras with error detection. An auxiliary lens and image sensor shares a housing with a main lens and image sensor which together act as a range finder to determine the distance to a scene. Scene distance is used in combination with contrast-detection autofocus to achieve maximum sharpness in the image. Errors in distance determination may be found and corrected using a comparison of data collected from the auxiliary lens and main lens.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

1. Field of the Invention

The present application relates generally to digital image processing, and more specifically to methods and systems for improving automatic digital image focus.

2. Description of the Related Art

An automatic focusing (autofocus) feature of a digital imaging system (for example, a digital camera) provides functionality to the system to bring into focus the object or scene of interest quickly and smoothly, from a distant scene to a close-up shot. An autofocus feature generally uses the sharpness or contrast value of a number of images captured using different lens positions of a moveable lens assembly (the lens positions corresponding to different focusing distances) to determine the appropriate lens position. The autofocus feature then moves the lens to the appropriate position to bring the object or scene into focus.

There are generally two types of distance estimation methods for cameras. One type of distance estimation is an active sensor. Active sensors can include ultrasound or light from a laser to measure the “time of flight,” or infrared to measure the angle of reflection. Another type of distance estimation is done with passive sensors. Examples of passive sensors include phase detection, which is achieved by dividing the incoming light into pairs of images and comparing them, and a dual camera system (for example, a range finder), which involves two calibrated cameras to provide focus information.

One challenge with present digital autofocus technologies is the time consuming nature of the autofocus operation. Another challenge is the inability of the digital camera to recognize when the camera lens is no longer calibrated correctly, which may be caused by events that result in physical displacement of the lens.

### SUMMARY OF THE INVENTION

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages.

One aspect of the disclosure provides an apparatus configured to capture images, comprising a main camera configured to capture images of a scene, including a lens assembly comprising at least one lens and having an adjustable focus, and a sensor. The apparatus further comprises a second camera positioned at a known distance from the main camera and configured to capture images of the scene, the second camera including a lens assembly comprising at least one lens, and a sensor. The apparatus further comprises a memory component configured to store images captured by the main camera and the second camera. The apparatus further comprises a range finder (also referred to herein as “dual camera”) configured to determine a first focus position based on a first image captured by the main camera and a second image captured by the second camera. The apparatus further comprises a focusing component operably configured to adjust focus of the main camera to the first focus position, move the focus of the main camera from the first focus position to a plurality of focus positions and determine a second focus position based on a plurality of images, one of the plurality of images captured by the main camera at each of the plurality of focus positions, and adjust focus of the main camera to the second focus position.

Another aspect of the disclosure provides a method for capturing images, the method comprising capturing images of a scene using a main camera, capturing images of the scene using a second camera, storing images captured by the main camera and the second camera using a memory component, determining a first focus position based on a first image captured by the main camera and a second image captured by the second camera, adjusting focus of the main camera to the first focus position using a focusing component, moving the focus of the main camera from the first focus position to a plurality of focus positions, determining a second focus position based on a plurality of images, one of the plurality of images captured by the main camera at each of the plurality of focus positions, and adjusting focus of the main camera to the second focus position.

Another aspect of the disclosure provides an apparatus configured to capture images, comprising a means for capturing images of a scene using a main camera, a means for capturing images of the scene using a second camera, a means for storing images captured by the main camera and the second camera using a memory component, a means for determining a first focus position based on a first image captured by the main camera and a second image captured by the second camera, a means for adjusting focus of the main camera to the first focus position using a focusing component, a means for moving the focus of the main camera from the first focus position to a plurality of focus positions, a means for determining a second focus position based on a plurality of images, one of the plurality of images captured by the main camera at each of the plurality of focus positions, and a means for adjusting focus of the main camera to the second focus position.

Another aspect of the disclosure provides a non-transitory computer-readable medium comprising code that, when executed, causes an apparatus configured to capture images to capture images of a scene using a main camera, capture images of the scene using a second camera, store images captured by the main camera and the second camera using a memory component, determine a first focus position based on a first image captured by the main camera and a second image captured by the second camera, adjust focus of the main camera to the first focus position using a focusing component, move the focus of the main camera from the first focus position to a plurality of focus positions, determine a second focus position based on a plurality of images, one of the plurality of images captured by the main camera at each of the plurality of focus positions, and adjust focus of the main camera to the second focus position.

### BRIEF DESCRIPTION OF THE DRAWINGS

FIG. 1 illustrates a simplified example of a mobile device containing a range finder camera system.

FIG. 2 illustrates a simplified block diagram of a digital camera configured using a dual camera range finder.

FIG. 3 illustrates a simplified block diagram of a processor and the peripheral hardware integrated with the processor.

FIG. 4 illustrates an example of the quantity of lens movements required to achieve optimum focus using a contrast detection autofocus method.

FIG. 5 illustrates an example of the quantity of lens movements to achieve optimum focus using an embodiment of a combination dual camera autofocus and contrast detection autofocus method.

FIG. 6 illustrates a simplified example block diagram of a range finder error detection system.

FIG. 7 is a flowchart illustrating a method, in accordance with an exemplary embodiment of the present invention.

### DETAILED DESCRIPTION OF THE PREFERRED EMBODIMENT

The following detailed description is directed to certain specific embodiments of the invention. However, the invention can be embodied in a multitude of different ways. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to, or other than one or more of the aspects set forth herein.

The examples, systems, and methods described herein are described with respect to digital camera technologies. The systems and methods described herein may be implemented on a variety of different digital camera devices. These include general purpose or special purpose digital camera systems, environments, or configurations. Examples of digital camera systems, environments, and configurations that may be suitable for use with the invention include, but are not limited to, digital cameras, hand-held or laptop devices, and mobile devices (e.g., phones, smart phones, Personal Data Assistants (PDAs), Ultra Mobile Personal Computers (UMPCs), and Mobile Internet Devices (MIDs)).

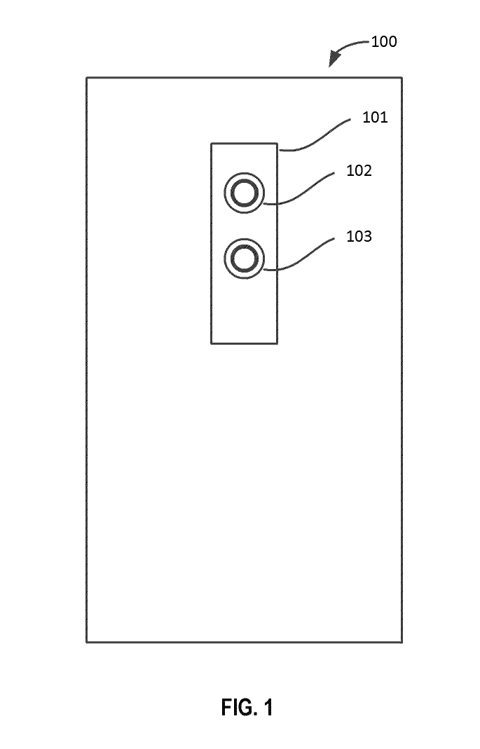

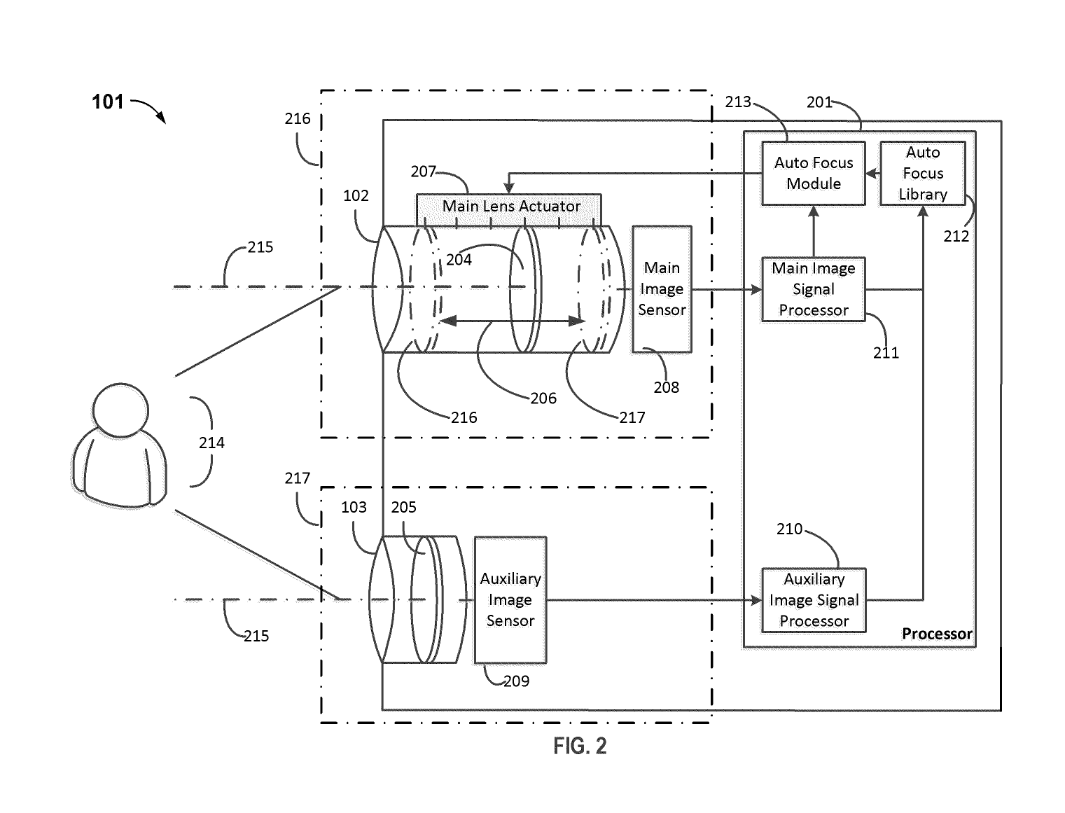

FIG. 1 illustrates an example of one embodiment of an imaging device 100 that can include systems and methods for improving autofocus using two cameras. The imaging device 100 may be, for example, a mobile device including a cell phone, a camera, a tablet computer, or another device configured to capture images. The illustrated imaging device 100 includes a housing of the camera system 101, and may be a separate and distinct component within the mobile device 100, combined with the mobile device 100, or substantially make up the mobile device 100. The mobile device 100 may provide a surrounding structural housing for the camera system 101. Further to this exemplary embodiment, the camera system 101 may contain its own processor 201 (as illustrated in FIG. 2) to provide functionality to the camera system 101, or the mobile device 100 itself may include a processor 201 whose function to the camera system 101 is ancillary to that of the mobile device 100. The camera system 101 may include a main lens housing 102 and an auxiliary lens housing 103, each comprising a separate image sensor, the combination of which can function as a range finder 212 and allow for distance estimation 303 between the camera system 101 and a current scene. The main and auxiliary lens housings 102 and 103 may be separated by a known distance from each other. The optical axis of each of the main and auxiliary lens housings 102 and 103 may be aligned to have matching orientation, facing outward from the mobile device 100 to have the same (or substantially the same) field of view (FOV) 215.

FIG. 2 illustrates a block diagram of an exemplary camera system 101 according to some embodiments. As previously discussed, the camera system 101 may include two separate lens components: (1) a main 216, and (2) an auxiliary 217. The main lens component 216 may include a main lens 204 which may be in some embodiments a single lens, or a plurality of lenses or optical elements. The main lens component 216 may also include a main lens housing 102 structure containing the main lens 204, and a main lens actuator 207 to enable movement of at least one lens 204, and a main image sensor 208. The auxiliary component 217 may include a structure containing the lens 103, at least one lens 205, and an auxiliary image sensor 209. The camera system may further include a functional interface between both the main image sensor 208 and the auxiliary image sensor 209. This interface may also include a physical interface, for example, a processor 201 or other logic circuitry or signal processing component, connected wirelessly or via hardware. In one example, the processor 201 may respond to, and process data provided by, at least one image sensor (208 and 209).

As described above, FIG. 2 illustrates an example of an embodiment of camera system 101. The camera system 101 includes a main lens housing 102 for a main lens 204. The main lens housing 102 provides a structure for containing and positioning a main lens 204. The main lens 204 includes at least one lens. The main lens housing 102 may further be configured to allow movement of the main lens 204 along a fixed path within the main lens housing 102 while maintaining a fixed facing orientation of the main lens 204. The main lens housing 102 provides a focus control function 213 wherein the main lens 204 is positioned to a first or initial main lens position 206 using the main lens actuator 207. In one example embodiment, the focus control function 213 may use data provided by a range finder function 212, data provided by a contrast auto focus function 301, or both. The main lens actuator 207 may be physically connected to, or a part of, the lens housing 102, or may be a separate component. In one example embodiment, a distance estimation and a disparity value 303 may be calculated using at least the main lens housing 102 and the auxiliary lens housing 103 along with their associated image sensors (211 and 210) as a range finder 212 to determine a first focus position 704. Alternatively, the focus control function 213 may provide a first or initial main lens position 206 based on contrast detection autofocus using the main lens housing 102, a main image sensor 208, and a processor 201 to calculate a contrast or sharpness value based on a plurality of main lens positions 206. Besides providing a focus control function 213, the main lens housing 102 may be configured to support the attachment of temporary and permanent fixtures to the housing. For example, the main lens housing 102 may be configured comprising a magnetic material, a threaded member or receiver, or other method of attachment. This can allow a user the option of attaching additional lenses, one or more photography filters, or a variety of other attachments to further improve the user's experience. The main lens housing 102 may also be designed to include a fixed or adjustable aperture to collimate the light allowed to the main image sensor 208.

As further shown in FIG. 2, the camera system 101 may contain an auxiliary lens housing 103. The auxiliary lens housing 103 provides a structure for containing an auxiliary lens 205 arrangement and may be configured to allow movement of the auxiliary lens 205 along a fixed path within the housing while maintaining a fixed orientation 215, or alternatively, the lens housing 103 may hold the auxiliary lens 205 arrangement in a fixed position with an orientation substantially to that of the main lens 204. As with the main lens housing 102, the auxiliary lens housing 103 may be configured to support the attachment of temporary and permanent fixtures to the housing. The auxiliary lens housing 103 may also be designed to include a fixed or adjustable aperture to collimate the light allowed to the auxiliary image sensor 209.

As illustrated in the embodiment of FIG. 2, the camera system 101 further includes the main image sensor 208. The main image sensor 208 may receive the light of an optical image 214 through the main lens 204 and convert the light into an electronic signal made up of the image statistics for a particular frame. An image frame is a single static image captured by an image sensor (208 and 209). In an exemplary embodiment, an image sensor may capture at least one image frame at each main lens position 206, and may further store the image statistics along with the particular lens position associated therewith in a memory component 302. The image statistics of a scene 214 may be manipulated by adjusting the position of the main lens 204 using the main lens actuator 207. Accordingly, the main image sensor 208 may be coupled to the main lens housing 102 or alternatively, as a stand-alone element of the camera system 101. The main image sensor 208 may also be integrated with a signal processor 211 or other computing medium with the ability to process an electronic signal.

The main lens 204 may be allowed to adjust its position within the housing 102 to focus the light of a particular scene while maintaining a proper lens facing orientation 215. The main lens 204 may be further coupled with a main lens actuator 207 to provide the lens position 206 adjustments. In some embodiments, the main lens 204 may be designed as a Double Gauss or Cooke triplet lens. In some embodiments, the main lens 204 may be molded plastic or glass, and may be a group of lens elements made with a variation of dispersion and refractive indexes.

The main lens actuator 207 provides a means for adjusting the position of the main lens 204. In one exemplary embodiment, an electro-mechanical system may be used to allow precision adjustments in the main lens position 206 in order to achieve optimal image focus. For example, the main lens 204 may be moved using a micro-electro-mechanical-system (MEMS) to provide linear movement, allowing the lens 204 to be moved in precision increments and allowing the main image sensor 208 to capture an image frame at each increment. In another example, the main lens 204 is moved by step motors that can iteratively position the lens to discrete positions 206 for the collection of a frame at each lens position 206. The main lens 204 may also be moved along a set of pre-programmed discrete lens positions 206 within the main lens housing 102. Accordingly, the main lens actuator 207 can move the main lens 204 in coarse or fine increments along either a preprogrammed set of stages determined by a disparity value or distance calculation 303, or on an ad hoc basis determined by a contrast detection autofocus algorithm. The main lens actuator 207 may be integrated with either the main lens 204 or the main lens housing 102, or to both, and may be further integrated with a processor 201. Both the autofocus module 213 and the autofocus library 212 can store a collection of frames in a memory component for determining the lens location 206 that provides an image with the highest contrast or sharpness, and for calculation of a disparity value and an estimated distance 303 as described below.

FIG. 2 further illustrates a camera system 101 comprising an auxiliary image sensor 209. The auxiliary image sensor 209 may receive the light of an optical image 214 through the auxiliary lens housing 103. The light of the optical image 214 may be manipulated by using a fixed focus, wide angle or standard auxiliary lens 205. Accordingly, the auxiliary image sensor 209 may be coupled to the auxiliary lens housing 103 or to the auxiliary lens 205 itself. The auxiliary image sensor 209 converts the optical image 214 into an electronic signal containing the image statistics for that fixed frame, which is sent to the processor 201 in combination with the electronic signal from the main image sensor 208. The auxiliary image sensor 209 may also be coupled to a signal processor 210 or any other medium with the ability to process an electronic signal.

The auxiliary lens 205 can be integrated with the auxiliary lens housing 103 to maintain proper orientation and light collimation. The auxiliary lens 205 may be further coupled to an auxiliary image sensor 209 in order to produce image statistics based on each frame. The auxiliary lens 205 may be designed as a Double Gauss or Cooke triplet lens, but may be any molded plastic or glass aspheric lens elements made with a variation of dispersion and refractive indexes.

FIG. 2 further illustrates a processor 201 within the camera system 101 and integrated with the main image sensor 208, the main lens actuator 207, and the auxiliary image sensor 209. The processor may be an element of the camera system itself, or may be an element associated with an independent system of which the camera system 101 is incorporated (e.g., a processor belonging to a mobile device 101). Both the main image sensor 208 and the auxiliary image sensor 209 may function to measure the light intensity provided by an optical image 214 and convert that light into an electronic signal made up of the image statistics for each frame. The image statistics provided by the sensors may supply the processor 201 with the data necessary to process the image frames from at least one image sensor. The processor 201 may control the main lens actuator 207 which can adjust the location of the main lens 204 in order to focus the scene. Scene focusing can be based on the main sensor 208 image statistics alone or in conjunction with the image statistics provided by the auxiliary image sensor 209. Distance and directional movement of the main lens 204 may be based on direction provided by the autofocus module 213 and the autofocus library 212 calculations as explained below. The main Image Signal Processor (ISP) 211 and the auxiliary ISP 210 can be stand-alone signal processors or a set of algorithms performed by the processor 201 to process the sensor information. The main ISP 211 may be configured to collect image information from the main image sensor 208 and process the information to produce processed image frames or, stated differently, electrically coded still images, and autofocus statistics. The autofocus statistics may allow the autofocus module 213 to determine a main lens 204 position based on calculations done by at least one contrast-detection autofocus algorithm 301. The contrast detection autofocus algorithm 301 can make use of the image statistics by mapping them to a value that represents a main lens 204 position or, alternatively, may position the lens in non-discrete, ad-hoc positions. The processor 201 is also coupled to the main lens actuator 207 and can adjust the lens based on calculations made with the image information from at least one image sensor.

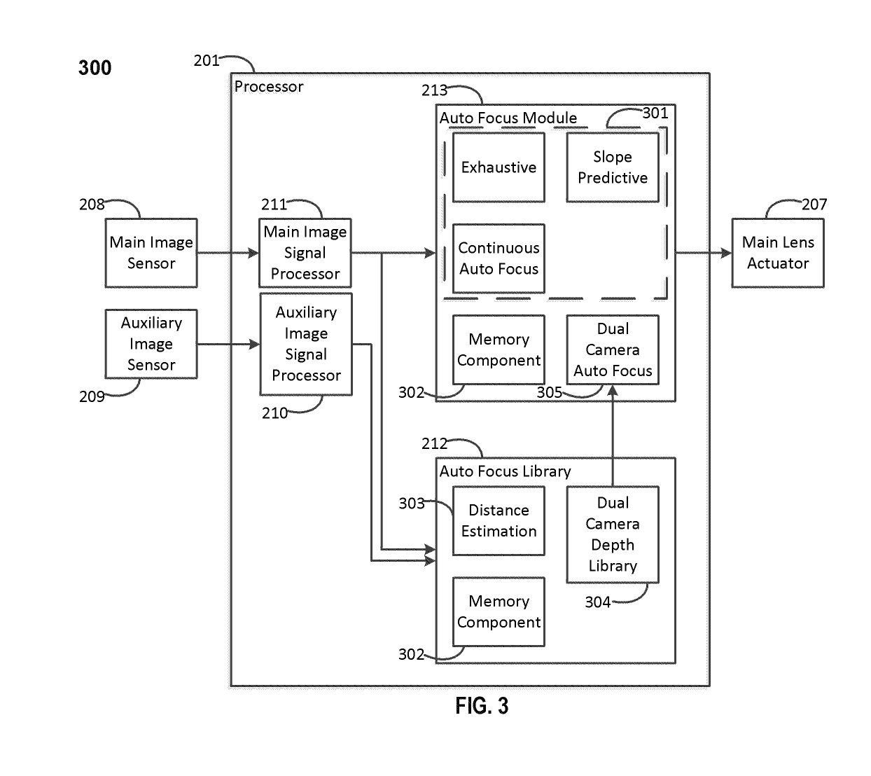

As illustrated in the example embodiment of FIG. 3, the main image sensor 208 and the auxiliary image sensor 209 are both integrated with a processor 201 that contains a main ISP 208 and an auxiliary ISP 209. Both image sensors (208 and 209) can provide two distinct sets of image information of the same scene 214 to a processor 201 or other digital signal processor. The processor 201 of FIG. 3 is an example embodiment that contains an autofocus module 213 and an autofocus library 212. The autofocus module 213 is functionally integrated with the main ISP 211, allowing for the communication of processed image data. The autofocus library 212 is similarly integrated with the main ISP 211 as well as the auxiliary ISP 210, allowing for communication of processed data from both ISPs. The autofocus module 213 may be comprised of a set of contrast detection algorithms 301, a memory component 302, and a dual camera autofocus algorithm 305, and may be integrated with the main lens actuator 207. Similarly, the autofocus library 212 may be compromised of a distance estimating algorithm 303 which can calculate a disparity value and estimate a distance of a particular scene, a dual camera depth library 304, and a memory component 302.

The autofocus module 213 may be a part of the processor function and can allow the processor 201 to control the main lens actuator 207. As shown in FIG. 3, the autofocus module 213 may be made up of several contrast detection algorithms 301. Generally, contrast detection algorithms 301 evaluate the image statistics received from the image sensor (208 and 209) at each lens position 206 then reevaluate to determine if there is more or less contrast. If contrast has increased, the lens is moved in that direction until contrast is maximized. If contrast is decreased, the lens is moved in the opposite direction. This movement of the lens is repeated until contrast is maximized. In one exemplary embodiment, the main lens actuator 207 may be activated to focus the main lens 204 on a particular scene 214 by employing algorithms of three specific types of contrast detection: (1) exhaustive autofocus, (2) slope predictive autofocus, and (3) continuous autofocus. Contrast detection autofocus makes use of a focus feature that maps an image to a value that represents the degree of focus of the image, and iteratively moves the lens searching for an image with the maximal focus according to the contrast detection algorithm 301. In one example, the user of the camera system 101 may determine which contrast detection autofocus algorithm 301 may be the most appropriate for a given scene 214 and select it to be used, or alternatively, the processor 201 may determine the appropriate algorithm based on image sensor (208 and 209) information. The main lens actuator may be activated by either a contrast detection algorithm 301, or a dual camera autofocus algorithm 305. The dual camera autofocus algorithm may activate the main lens actuator 207 to adjust the position of the main lens 206 using a digital lookup table with a range of lens positions 206 that correspond to a calculated distance or disparity value 303. The lookup table may be stored in the memory component 302. The autofocus module 213 may activate the main lens actuator 207 and adjust position of the main lens 206 using one or more contrast detection auto focus algorithms 301. The auto focus module 213 may further store the lens positions calculated by one or more algorithms, as well as the associated processed image frames, in the memory component 302.

The autofocus library 212 module can interface with both the main ISP 211 and the auxiliary ISP 210, as well as the dual camera autofocus 305 algorithm within the autofocus module 213. The autofocus library 212 may receive the processed image frames from both the main 211 and auxiliary 210 ISPs and determine a disparity value of the images to estimate the distance 303 between the camera system 101 and the scene being captured 214. In one example, the processor 201 may calculate the distance by determining the disparity value 303 between the image statistics or the processed image frames produced by the main 211 and auxiliary 210 ISPs. This distance estimation and the disparity value 303 may be stored for future use in a memory component 302. The autofocus library 212 may also include a dual camera depth library 304, wherein a distance estimation or a disparity value 303 can be correlated to a preconfigured main lens position 206. A particular distance estimation or disparity value 303 may relate to a specific lens position 206, and may be stored in a memory component or learned by comparing one or more distance estimations or disparity values 303 with lens positions 206 determined by contrast detection autofocus algorithms 301. The disparity value or estimated distance 303 of the scene can be used to command the main lens actuator 207 to make an initial or subsequent main lens adjustment 206.

As discussed above, the contrast detection algorithms 301 may continually move the lens and reevaluate the image statistics at each lens position to determine which lens position provides maximum contrast. This means the lens is required to move past a perfect position, then back to that position once contrast has started to decrease again, resulting in a slow focusing function. As illustrated in FIG. 3, the autofocus module 213 may include a dual camera autofocus element that can receive a lens position 206 determined by the autofocus library 212 and command the main lens actuator to move the lens to a position associated with the distance estimation or disparity value 303. This means the lens can be moved more rapidly into a perfect focus position using a dual camera autofocus algorithm in combination with the contrast detection algorithms described previously. The dual camera autofocus element may further store the distance estimation or disparity value 303 in the autofocus module 213 memory component.

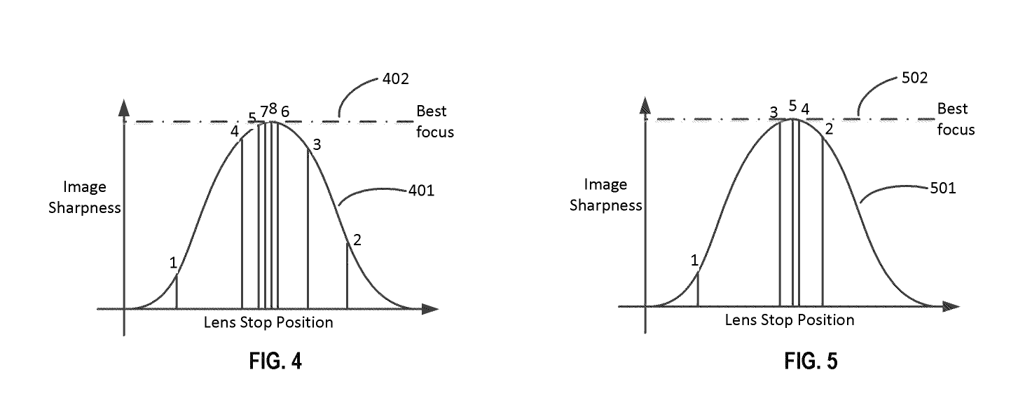

FIG. 4 illustrates a graph providing an example of the number of lens movements required for a contrast detection autofocus 301. In this figure, the y-axis represents a criteria that is used to determine whether an image is in focus, in this case image sharpness, but can also represent the contrast of the image in other embodiments. Using image sharpness as an example, the zero point or origin of the y-axis represents the lowest value of image sharpness, followed by an increase in the image sharpness as the value of the y-axis is increased from the zero point. A horizontal limit line intersects the y-axis 402, which represents the highest level of image sharpness or contrast produced as a function of main lens position 206. This highest level of sharpness (or contrast) is characterized by an image with the best focus of a scene 214.

Referring still to FIG. 4, the x-axis is representative of the main lens position 206 within the main lens housing 102, wherein the zero point or origin represents the main lens position 206 at its furthest retracted position inside the main lens housing 102. An increase in the x value along the x-axis represents the movement of the main lens 204 from the retracted position 217 within the main lens housing 102 toward the outermost extended lens position 216 within the main lens housing 102. Again, due to the limits of the range of which the main lens can move, the x-axis will have a maximum value that represents the extended lens position 216, and a minimum value representative of a fully retracted lens position 217 at the zero point.

Further concerning FIG. 4, a bell curve 401 is illustrated as stretching from the zero point across the x-axis, and is representative of image sharpness (y-axis) based on the main lens position 206 (x-axis). For the example shown in FIG. 4, the top of the bell curve 401 reaches the best focus value 402 at the center of the x-axis, or in other words, when the main lens 204 is at a position centered within the main lens housing 102. Within this bell curve 401 are eight vertical lines starting at the x-axis and extending to the edge of the bell curve 401. These lines are representative of main lens positions 206 using only a contrast detection autofocus algorithm 301 to determine proper main lens position 206. The contrast detection algorithm 301 captures an image at each of the lens positions and makes use of a focus measure that maps a captured image to a value that represents the degree of focus of the image. For example, FIG. 4 shows the main lens 204 is moved in eight different positions, each position marked with a number representative of the sequence of movements (e.g., first position marked with “1”, second position marked with “2”, etc.). The contrast detection algorithm 301 determines a lens position 206 by comparing the focus measure of images captured at different positions in order to narrow the lens position 206 to one that provides the best focus. FIG. 4 shows an example of an exhaustive autofocus algorithm 301 and the relatively high number of lens positions 206 required to reach a position that provides the best focus.

FIG. 5 illustrates a model for comparison of the techniques used to find a position that provides the best focus. As noted earlier, FIG. 4 illustrates a graph providing an example of the relatively high number of lens movements required for a contrast detection autofocus 301. In FIG. 5, however, shows an example of the relatively low number of lens movements required for a dual camera autofocus and contrast detection hybrid model. As with FIG. 4, the y-axis and x-axis in FIG. 5 represents image sharpness or image contrast (or another image characteristic that is used to indicate that an image is in focus), and main lens position 206 within the main lens housing 102, respectively. The bell curve 501 in FIG. 5 is identical to that in FIG. 4, and representative of image sharpness based on the main lens position 206. The primary difference between FIG. 4 and FIG. 5, are the number of vertical lines starting at the x-axis and extending to the edge of the bell curve 501. These lines are representative of main lens positions 206 using a dual camera autofocus 305 and contrast detection autofocus algorithm 301 hybrid system. The dual camera autofocus algorithm 305 determines an initial lens position based on a distance estimation or a disparity value 303 calculated from the processed frames from the main image sensor 208 and the auxiliary image sensor 209. In one exemplary embodiment, the distance estimation or the disparity value 303 may be correlated with a specific main lens location 206. Once the initial main lens position 206 is set, the autofocus algorithm 301 is used to fine tune the main lens position 206 in order to determine the position of best focus 502. This hybrid method of focusing the main lens 204 with both a dual camera 305 and contrast detection 301 autofocus results in a focusing process that can achieve a best focus with fewer lens movements than a system based only on contrast detection autofocus 301.

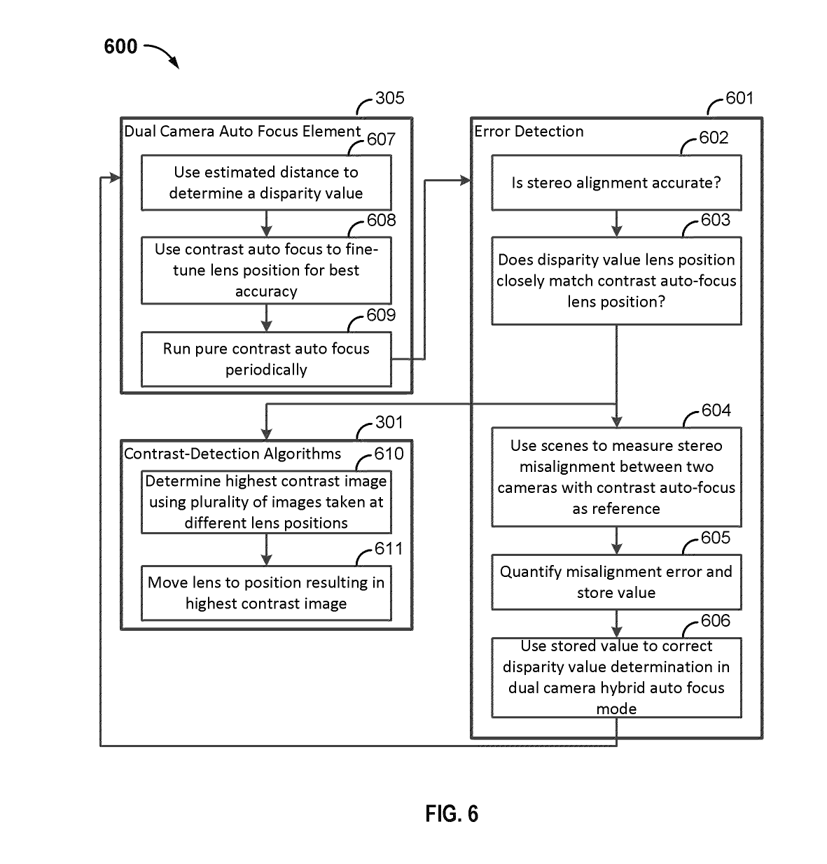

FIG. 6 illustrates a method of dual camera error detection wherein the dual camera autofocus element and contrast detection algorithms may determine inaccuracies in the camera system 101. In a non-limiting example, the error detection may determine if the stereo alignment of the main lens 204 and the auxiliary lens 205 is accurate, or if the lens position 206 provided by the autofocus library 212 closely matches the lens position determined by the contrast detection algorithms. The error detection may be initiated by periodically allowing the camera system 101 to focus on a scene using only contrast detection algorithms 301 in finding the first main lens position 206 for the current scene 214. This will allow the processor 201 to compare the first lens position as determined by the contrast detection algorithms with the first lens position determined by the auto focus library 212 and establish whether the difference in the lens position 206 between the two methods exceeds a preconfigured quality value. The delta value may be stored in a memory component and used to correct distance estimations or disparity value 303 determinations made by the autofocus library 212.

FIG. 6 further illustrates an exemplary method for which error detection is initiated. The dual camera autofocus element may initiate the first main lens position 206 change, followed by further adjustments to the main lens 204 using one or more contrast detection algorithms 301 that can determine a lens position 206 based on highest contrast or sharpness. However, the processor 201 may determine a first main lens position 206 change using only contrast detection algorithms. The contrast detection algorithms may determine a first main lens position 206 by comparing a plurality of images taken at different lens positions 206 to determine which lens position 206 provides the highest contrast image. This first main lens position 206 may then be compared to a main lens position 206 determined by a distance estimation or a disparity value 303 for the same scene. A stereo misalignment between the main lens 204 and the auxiliary lens 205 can be detected by comparing an image from each of the main image sensor 208 and the auxiliary image sensor 209. Upon detection of an error, the processor 201 may designate the contrast detection algorithms as the only method for main lens position 206 determination.

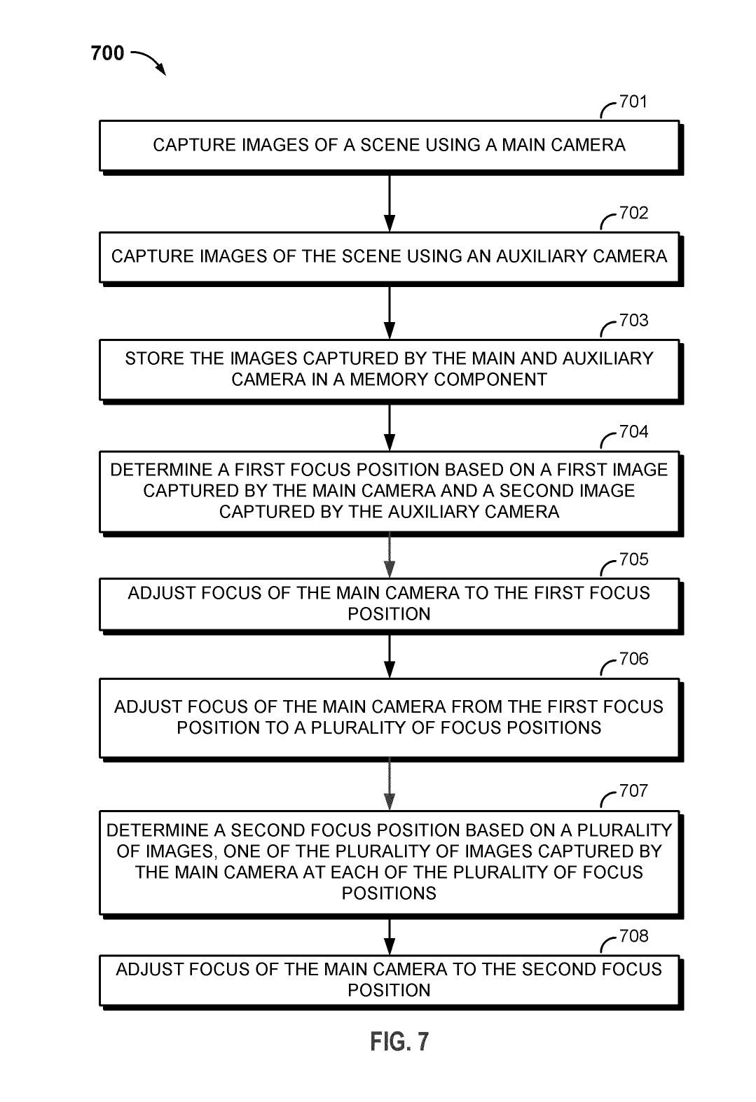

FIG. 7 illustrates an example method 700 by which a dual camera autofocus 305 and contrast detection autofocus algorithm 301 hybrid system may operate. Initially, 701 images of a scene 214 may be captured using a main image sensor 208. This process involves using the main image sensor 208 to convert the light of the scene 214 into an electronic signal that may contain the image statistics for the frame, as well as associated information including, but not limited to, the location of the main lens 206 at the moment the image is captured. The image statistics and associated information can be communicated to the processor 201. At essentially the same moment 702, an auxiliary image sensor 209 may be used to capture images of the same scene 214. Similarly, the auxiliary image sensor 209 converts the light of the scene into an electronic signal comprising the image statistics for the frame and associated data. Once the main 208 and auxiliary 209 image sensors communicate image statistics and associated information to the processor 201, the processor 201 may store the data in a memory component 302 and 703. The processor 201 will also process the image statistics from the main 208 and auxiliary 209 image sensors through an ISP (211 and 210, respectively). Determination of a first focus position 704 is made based on a disparity value or a distance estimation 303. The image statistics processed by the main 211 and auxiliary 210 ISPs can be communicated to the autofocus library 212 where the disparity value and the distance between the camera system and a point in the scene can be calculated 303 based on the image statistics or processed image data. The calculated distance estimation 303 value can correspond to a preconfigured main lens position 206. The autofocus module 213 commands the main lens actuator 207 to adjust the main lens 204 to the position associated with the disparity value or the distance estimation 303, thereby allowing adjustment of the focus of the main camera lens 204 to the first focus position 705.

After the main lens 204 is adjusted to the first focus position 705, an additional image frame may be processed by the main ISP 211 and communicated to the autofocus module 213. As noted above, at least one contrast detection autofocus algorithm 301 may be used to evaluate the contrast or sharpness of an image captured at the first focus position 705. Subsequently 706, the autofocus module may command the main lens actuator to make a plurality of main lens position 206 adjustments in addition to the first focus position 705, and evaluate the processed images captured at each of the plurality of lens position 206 using at least one contrast detection autofocus algorithm 301. Based on an evaluation of the plurality of images captured by the main camera at each of the plurality of focus positions 707, the autofocus module will make a determination of which main lens position 206 of the plurality of lens positions provides the highest contrast or sharpness value. This results in an adjustment of the focus of the main camera from one of the plurality of focus positions to a second focus position 708.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

1. An apparatus configured to capture images, comprising:
a main camera configured to capture images of a scene, including:
a lens assembly comprising at least one lens and having an adjustable focus, and
a sensor;
a second camera positioned at a known distance from the main camera and configured to capture images of the scene, the second camera including:
a lens assembly comprising at least one lens, and
a sensor;
a memory component configured to store images captured by the main camera and the second camera;
a range finder configured to determine a first focus position based on a first image captured by the main camera and a second image captured by the second camera;
a processor operably configured to:
adjust focus of the main camera to the first focus position,
move the focus of the main camera from the first focus position to a plurality of focus positions and determine a second focus position based on a plurality of images captured by the main camera at each of the plurality of focus positions; and
adjust focus of the main camera to the second focus position.

2. The apparatus of claim 1, wherein the processor is further configured to determine the second focus position by determining an image of the plurality of images that has the highest contrast, determining the focus position of the image having the highest contrast, and setting the second focus position to be the same as the focus position of the image having the highest contrast.

3. The apparatus of claim 1, wherein the memory component is configured to have stored therein a set of focus positions that relate to a distance value or a disparity value calculated from the first image and the second image.

4. The apparatus of claim 3, wherein the range finder determines the first focus position by estimating a distance between the apparatus and a point in the scene.

5. The apparatus of claim 4, wherein the distance value is calculated from the disparity value.

6. The apparatus of claim 1, wherein the processor is operably coupled to an actuator, the actuator configured to adjust the focus of the main camera to the plurality of focus positions.

7. The apparatus of claim 1, wherein the range finder comprises the main camera and the auxiliary second camera.

8. The apparatus of claim 1, wherein the processor is further configured to determine an accuracy of the range finder by determining a main lens position delta between (1) a first focus position determined by the image that has the highest contrast and (2) the first focus position determined by calculating a distance value.

9. The apparatus of claim 8, wherein the memory component is configured to store the main lens position delta.

10. The apparatus of claim 9, wherein the processor is further configured to adjust the focus of the main camera to the first focus position based at least in part on the stored main lens position delta.

11. The apparatus of claim 4, wherein the memory component is further configured to store the estimated distance between the apparatus and the point in the scene.

12. The apparatus of claim 1, wherein the second camera comprises a fixed focus lens.

13. A method for capturing images, the method comprising:
capturing images of a scene using a main camera;
capturing images of the scene using a second camera;
storing images captured by the main camera and the second camera using a memory component;
determining a first focus position based on a first image captured by the main camera and a second image captured by the second camera;
adjusting focus of the main camera to the first focus position using a processor is operably coupled to an actuator;
moving the focus of the main camera from the first focus position to a plurality of focus positions;
determining a second focus position based on a plurality of images, one of the plurality of images captured by the main camera at each of the plurality of focus positions; and
adjusting focus of the main camera to the second focus position.

14. The method of claim 13, further comprising:
determining a disparity value based on the first image captured by the main camera and the second image captured by the second camera; and
storing the disparity value in a memory component.

15. The method of claim 13, further comprising:
estimating a distance value from the main camera to a point in the scene using image statistics of the first image captured by the main camera and the second image captured by the second camera to calculate a disparity value; and
storing the distance value in the memory component.

16. The method of claim 13, further comprising:
determining the second focus position using the processor;
determining the image of the plurality of images that has the highest contrast;
determining a focus position of the image having the highest contrast; and
setting the second focus position to be the same as the focus position of the image having the highest contrast.

17. The method of claim 13, further comprising:
retrieving a set of lens position values stored in the memory component, the lens position values corresponding to a plurality of distance values or disparity values;
determining which of the lens positions correspond with one of the plurality of the distance values or the disparity values, wherein the first focus position comprises the lens position that corresponds with one of the plurality of the distance values or disparity values.

18. The method of claim 13, further comprising:
adjusting the focus of the main camera to the plurality of focus positions using an actuator.

19. The method of claim 13, further comprising:
determining a main lens position delta between (1) the first focus position determined by the image that has the highest contrast and (2) the first focus position determined by calculating a distance value, and
determining an accuracy of the first focus position using the processor.

20. The method of claim 19, further comprising:
storing the main lens position delta in the memory component.

21. The method of claim 20, further comprising:
adjusting the focus of the main camera to the first focus position based at least in part on the stored main lens position delta.

22. An apparatus configured to capture images, comprising:
a first means for capturing images of a scene;
a second means for capturing images of the scene;
means for storing images captured by the first means for capturing images and the second means for capturing images using a memory component;
means for determining a first focus position based on a first image captured by the first means for capturing images and a second image captured by the second means for capturing images;
means for adjusting focus of the first means for capturing images to the first focus position;
means for moving the focus of the first means for capturing images from the first focus position to a plurality of focus positions;
means for determining a second focus position based on a plurality of images, one of the plurality of images captured by the first means for capturing images at each of the plurality of focus positions; and
means for adjusting focus of the first means for capturing images to the second focus position.

23. The apparatus of claim 22, wherein the means for determining the first focus position is a range finder.

24. The apparatus of claim 23, further comprising means for determining an error in the range finder.

25. The apparatus of claim 22, wherein the means for determining the second focus position is a contrast auto focus function.

26. The apparatus of claim 22, wherein:
means for determining the image of the plurality of images that has the highest contrast comprises a processor;
means for determining the focus position of the image having the highest contrast comprises the processor; and
means for setting the second focus position to be the same as the focus position of the image having the highest contrast comprises the processor.

27. The apparatus of claim 22, wherein:
means for storing a set of lens position values comprises a first memory component;
means for determining the first focus position by calculating a disparity value between one or more features in the first image and the second image comprises a processor; and
means for determining which of the plurality of lens focus positions corresponds with the disparity value comprises the processor.

28. A non-transitory computer-readable medium comprising code that, when executed, causes an apparatus configured to capture images to:
capture images of a scene using a main camera;
capture images of the scene using a second camera;
store images captured by the main camera and the second camera using a memory component;
determine a first focus position based on a first image captured by the main camera and a second image captured by the second camera;
adjust focus of the main camera to the first focus position using a processor operably coupled to an actuator;
move the focus of the main camera from the first focus position to a plurality of focus positions;
determine a second focus position based on a plurality of images, one of the plurality of images captured by the main camera at each of the plurality of focus positions; and
adjust focus of the main camera to the second focus position.

29. The non-transitory computer readable medium of claim 28, further configured to determine the first focus position based on a range finder function.

30. The non-transitory computer readable medium of claim 29, further configured to detect an error in the range finder function.
